(19) United States
(12) Patent Application Publication
(10) Pub. No.: US 2024/0257026 A1
(43) Pub. Date: Aug. 1, 2024

(54) SKILL DIAGNOSIS DEVICE, SKILL DIAGNOSIS METHOD, AND NON-TRANSITORY COMPUTER-READABLE RECORDING MEDIUM

(71) Applicant: MANAGEMENT SOLUTIONS CO., LTD., Tokyo (JP)

(72) Inventors: Shinya TAKAHASHI, Tokyo (JP); Toshinari GOTO, Tokyo (JP); Akira KANEKO, Tokyo (JP); Ryo HASEGAWA, Tokyo (JP); Yi ZHANG, Tokyo (JP)

(73) Assignee: MANAGEMENT SOLUTIONS CO., LTD., Tokyo (JP)

(21) Appl. No.: 18/629,365

(22) Filed: Apr. 8, 2024

Related U.S. Application Data
(63) Continuation of application No. PCT/JP2022/038060, filed on Oct. 12, 2022.

(30) Foreign Application Priority Data
Oct. 21, 2021 (JP) 2021-172335

(51) Int. Cl. G06Q 10/0639; G06Q 10/10

(52) U.S. Cl. CPC G06Q 10/06398; G06Q 10/103

(57) ABSTRACT

A skill diagnosis device includes a question storage configured to store a question for skill diagnosis related to project management, a diagnosis executor configured to read the question for skill diagnosis from the question storage, transmit the question for skill diagnosis to a first terminal used by an organization member, and receive an answer result to the question for skill diagnosis from the first terminal, an answer result storage configured to store the answer result received from the first terminal, a diagnoser configured to diagnose a skill of the organization member based on the answer result stored in the answer result storage, and an outputter configured to output a diagnosis result of the diagnose. The diagnosis result includes a classification of a human resource type representing an ability or an action characteristic capable of taking a specific action.

### CROSS-REFERENCE TO RELATED APPLICATION

This application is a continuation application of International Application PCT/JP2022/038060 filed on Oct. 12, 2022 and designated the U.S., which claims the benefits of priorities of Japanese Patent Application No. 2021-172335 filed on Oct. 21, 2021, the entire contents of which are incorporated herein by reference.

### FIELD

The present invention relates to a skill diagnosis device, a skill diagnosis method, and a non-transitory computer-readable recording medium.

### BACKGROUND

A project is a group of one or more project members to solve a specific problem. Project members are selected (assigned) from the organization members of the organization that has jurisdiction over the project. An organization leader is a person responsible for overseeing the organization members and a plurality of projects, such as a manager, department head, or executive. The organization leader may belong to one of the projects as a leader of one of the projects. Note that the technique related to the present disclosure is disclosed in Japanese Laid-open Patent Publication No. 2003-030384.

### SUMMARY

According to a first aspect of the present disclosure, there is provided a skill diagnosis device including a question storage configured to store a question for skill diagnosis related to project management; a diagnosis executor configured to read the question for skill diagnosis from the question storage, transmit the question for skill diagnosis to a first terminal used by an organization member, and receive an answer result to the question for skill diagnosis from the first terminal; an answer result storage configured to store the answer result received from the first terminal; a diagnoser configured to diagnose a skill of the organization member based on the answer result stored in the answer result storage; and an outputter configured to output a diagnosis result of the diagnoser; wherein the diagnosis result includes a classification of a human resource type representing an ability or an action characteristic capable of taking a specific action.

In the above skill diagnosis device, the question for skill diagnosis may include a question to understand competency, and the diagnoser may diagnose the human resource type based on an answer result to the question to understand the competency out of the answer result stored in the answer result storage.

In the above skill diagnosis device, the diagnosis executor may transmit at least a part of a plurality of questions to understand the competency to a second terminal used by a member other than the organization member, and may receive an answer result to the at least the part of the plurality of questions from the second terminal, and the diagnoser may reflect the answer result received from the second terminal in the diagnosis of the human resource type.

In the above skill diagnosis device, the diagnosis result may include skill levels of knowledge and experience related to the project management.

In the above skill diagnosis device, the question storage may store a question to understand a mental condition with respect to a project of an organization member belonging to the project, the diagnosis executor may read the question to understand the mental condition from the question storage, transmit the question to understand the mental condition to the first terminal, and receive an answer result to the question to understand the mental condition from the first terminal, and the diagnoser may diagnose the mental condition of the organization member belonging to the project based on the answer result to the question to understand the mental condition out of the answer result stored in the answer result storage.

In the above skill diagnosis device, the outputter may transmit the diagnosis result of the diagnoser to the first terminal.

In the above skill diagnosis device, the outputter may transmit a past diagnosis result with respect to the organization member by the diagnoser to the first terminal.

In the above skill diagnosis device, the outputter may transmit an aggregate result of diagnosis results by the diagnoser for a plurality of organization members belonging to a specific project to any one of terminals in response to a request from the any one of terminals.

In the above skill diagnosis device, the outputter may transmit a ratio of the human resource types determined for each characteristic of a project to any one of terminals.

In the above skill diagnosis device, the skill diagnosis device further may include a determiner configured to perform comparison determination between a classification of the human resource type diagnosed by the diagnoser for a plurality of organization members in a specific project to which the plurality of organization members belong and a ratio of a human resource type determined for each characteristic of the specific project.

According to a second aspect of the present disclosure, there is provided a skill diagnosis method executed by a computer to execute a process. The computer may include a question storage configured to store a question for skill diagnosis related to project management. The process may include: reading the question for skill diagnosis from the question storage, transmitting the question for skill diagnosis to a first terminal used by an organization member, and receiving an answer result to the question for skill diagnosis from the first terminal; storing the answer result received from the first terminal; diagnosing a skill of the organization member based on the stored answer result; and outputting a diagnosis result. The diagnosis result may include a classification of a human resource type representing an ability or an action characteristic capable of taking a specific action.

According to a third aspect of the present disclosure, there is provided a non-transitory computer-readable storage medium having stored therein a program for causing a computer to execute a process. The computer may include a question storage configured to store a question for skill diagnosis related to project management. The process may include: reading the question for skill diagnosis from the question storage, transmitting the question for skill diagnosis to a first terminal used by an organization member, and receiving an answer result to the question for skill diagnosis from the first terminal; storing the answer result received from the first terminal; diagnosing a skill of the organization member based on the stored answer result; and outputting a diagnosis result. The diagnosis result may include a classification of a human resource type representing an ability or an action characteristic capable of taking a specific action.

### BRIEF DESCRIPTION OF THE DRAWINGS

FIG. 1 is a diagram for explaining the definition of each term in skill diagnosis;

FIG. 2 is a diagram illustrating a purpose of performing skill diagnosis;

FIG. 3 is a diagram for explaining skill diagnosis;

FIGS. 4A and 4B are diagrams for explaining knowledge and experience required for project management;

FIG. 5 is a diagram for explaining competency required for project management;

FIGS. 6A to 6C are diagrams for explaining competency required for project management;

FIG. 7 is a block diagram of a skill diagnosis system according to an embodiment;

FIG. 8A is a block diagram of a member terminal, a skill diagnosis device, and an organization leader terminal;

FIG. 8B is a block diagram for explaining the hardware configuration of the skill diagnosis device;

FIG. 9 is a diagram illustrating a question database stored in a question storage unit;

FIG. 10 is a diagram illustrating a skill diagnosis screen displayed on a display device;

FIG. 11 is a diagram illustrating a mental diagnosis screen displayed on the display device;

FIG. 12 is a diagram illustrating an input result database stored in an answer result storage unit;

FIG. 13 is a diagram for explaining each human resource type;

FIG. 14 is a diagram illustrating a screen of an individual diagnosis result displayed on the display device;

FIG. 15 is a diagram illustrating a screen of an individual diagnosis result displayed on the display device;

FIG. 16 is a diagram illustrating a screen of a project diagnosis result displayed on the display device;

FIG. 17 is a diagram illustrating a screen of a project diagnosis result displayed on the display device.

FIG. 18 is a diagram illustrating a screen of a project diagnosis result displayed on the display device.

FIG. 19 is a diagram illustrating a screen of a project diagnosis result displayed on the display device;

FIG. 20 is a diagram illustrating a screen of an organization diagnosis result displayed on the display device;

FIG. 21 is a diagram illustrating a screen of an organization diagnosis result displayed on the display device;

FIG. 22 is a diagram illustrating a screen of an organization diagnosis result displayed on the display device;

FIG. 23 is a diagram illustrating a screen of an organization diagnosis result displayed on the display device;

FIG. 24 is a flowchart illustrating an example of processing executed by the skill diagnosis device;

FIG. 25 is a flowchart illustrating an example of processing executed by the skill diagnosis device;

FIG. 26 is a diagram illustrating an assignment; and

FIG. 27 is a diagram illustrating a predetermined ratio of human resource types.

### DESCRIPTION OF EMBODIMENTS

A project is a fixed-term operation to create a unique product or service. Project management is the activity undertaken to ensure the successful completion of the project. The project can have different characteristics depending on its object, content, and so on. For example, some projects require a clear focus on what needs to be done and what deliverables need to be generated, and require a short, high-quality completion period while other projects require innovative thinking and innovative procedures to create new services that are not available in the world.

Therefore, different project characteristics may require different skills for the organization members selected as project members. It is therefore desirable to understand the skills of the organization members assigned to each project. However, it is difficult to understand the skills of each organization member.

The present disclosure has been made in view of the above problems, and an object of the present disclosure is to provide a skill diagnosis device, a skill diagnosis method, and a non-transitory computer-readable recording medium that can understand the skills of organization members to be assigned to each project.

Hereinafter, embodiments will be described with reference to the drawings.

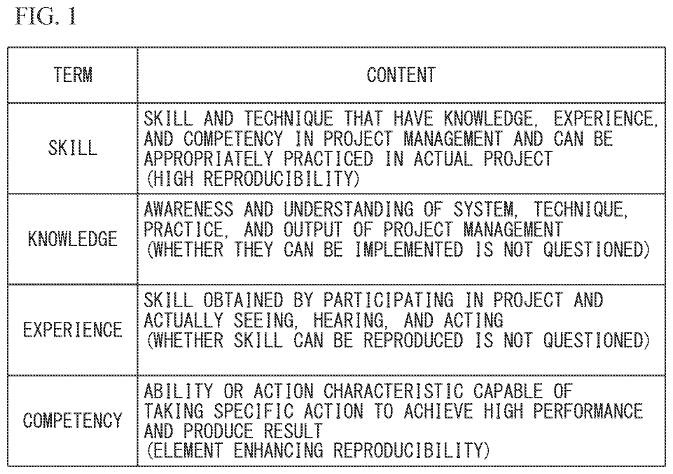

First, the definition of each of terms in the skill diagnosis according to the present embodiment will be described. As illustrated in FIG. 1, a “skill” represents skills and techniques that have knowledges, experiences, and competencies with respect to project management and can be appropriately practiced in an actual project.

A “knowledge” represents awareness and understanding of systems, techniques, practices, and outputs of the project management. The systems, techniques, practices and outputs of the project management are not questioned as to whether they can be implemented.

An “experience” represents skills obtained by participating in a project and actually seeing, hearing, and acting. It is not questioned as to whether these skills can be reproduced.

A “competency” represents an ability or an action characteristic capable of taking specific actions to achieve high performance and produce results. The competency is an element that enhances reproducibility.

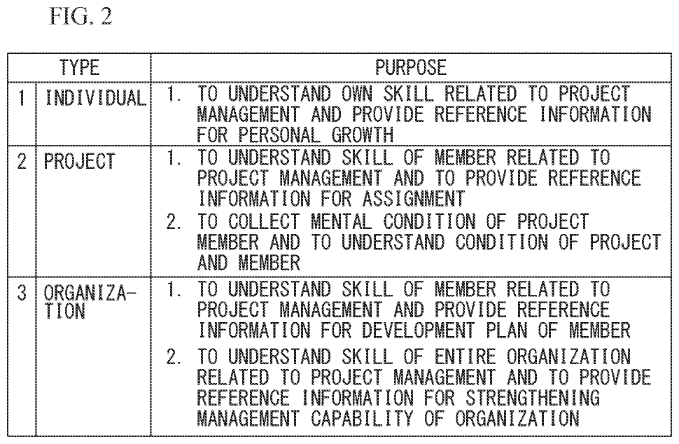

FIG. 2 is a diagram illustrating a purpose of performing the skill diagnosis. As illustrated in FIG. 2, the purpose of skill diagnosis for an individual organization member is to understand own skills related to the project management and provide reference information for personal growth. The purpose of the mental diagnosis for an individual organization member assigned to the project is for the organization member assigned to the project to understand own mental conditions.

The purpose of skill diagnosis for organization members is to understand the skills of each organization member related to the project management and to provide reference information for member development and assignment to project. The assignment is assignment of each member to each project. The mental diagnosis for each project is to collect the mental conditions of the organization members assigned to the project, to understand the conditions of the project and the organization members, and to understand whether the mental environment for each organization member to execute the project is prepared.

The purpose of skill diagnosis for organization with a plurality of projects is to understand the skills of each member related to the project management and provide reference information for the development plan of each member. Further, the purpose of skill diagnosis for organization with the plurality of projects is to understand the skills of the entire organization related to the project management and to provide reference information for strengthening the management capabilities of the organization.

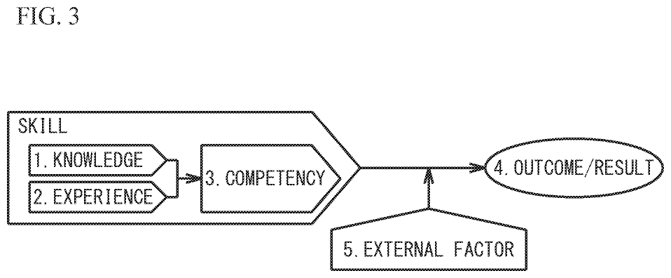

As described above, since the “skill” represents skills and techniques that possess knowledges, experiences, and competencies in the project management and can be appropriately practiced in actual projects, the skill diagnosis can be realized by standardizing knowledges, experiences, and competencies and comprehensively evaluating each level thereof, as illustrated in FIG. 3. Furthermore, by adding external factors such as the environment surrounding the project to the diagnosed skills, the outcomes and results of each project can be evaluated.

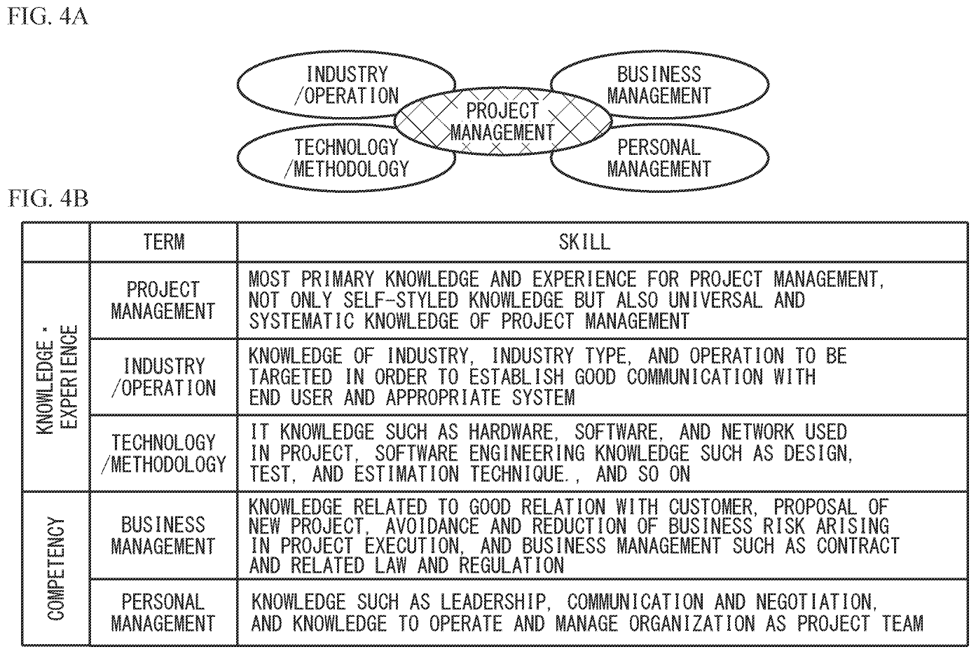

The knowledges and the experiences required for project management can be divided into five regions, as illustrated in FIG. 4A. The five regions are “project management”, “industry/operation”, “technology/methodology”, “business management”, and “personal management”. The knowledges and the experiences of “project management” are the most primary knowledges and experiences for project management, not only self-styled knowledges but also universal and systematic knowledges of the project management. The knowledges and experiences of “industry/operation” are knowledges of the industry, industry type, and operation to be targeted in order to establish good communication with end users and appropriate systems. The knowledges and the experiences of “technology/methodology” include IT (Information Technology) knowledges such as hardware, software, and networks used in the project, and software engineering knowledges such as design, test, and estimation techniques. The knowledges and the experiences of “business management” include knowledges related to good relations with customers, proposal of new projects, avoidance and reduction of business risks arising in project execution, and business management such as contracts and related laws and regulations. The knowledges and the experiences of “personal management” include knowledges such as leadership, communication and negotiation, and knowledges to operate and manage the organization as a project team.

Since the “business management” and the “personal management” in these five regions have a strong relationship with competencies, in the present embodiment, they are linked to the result of competencies instead of the knowledges and the experiences.

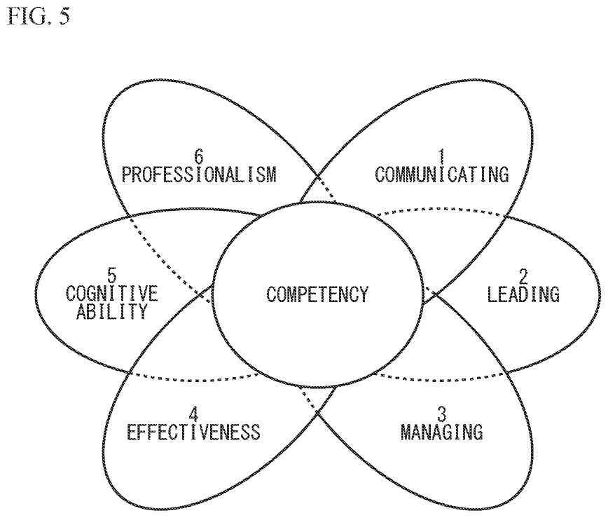

In the present embodiment, the competencies required for project management are further divided into six regions in addition to the viewpoints of “business management” and “personal management” as illustrated in FIG. 5. The six regions are “communicating”, “leading”, “managing”, “effectiveness”, “cognitive ability”, and “professionalism”.

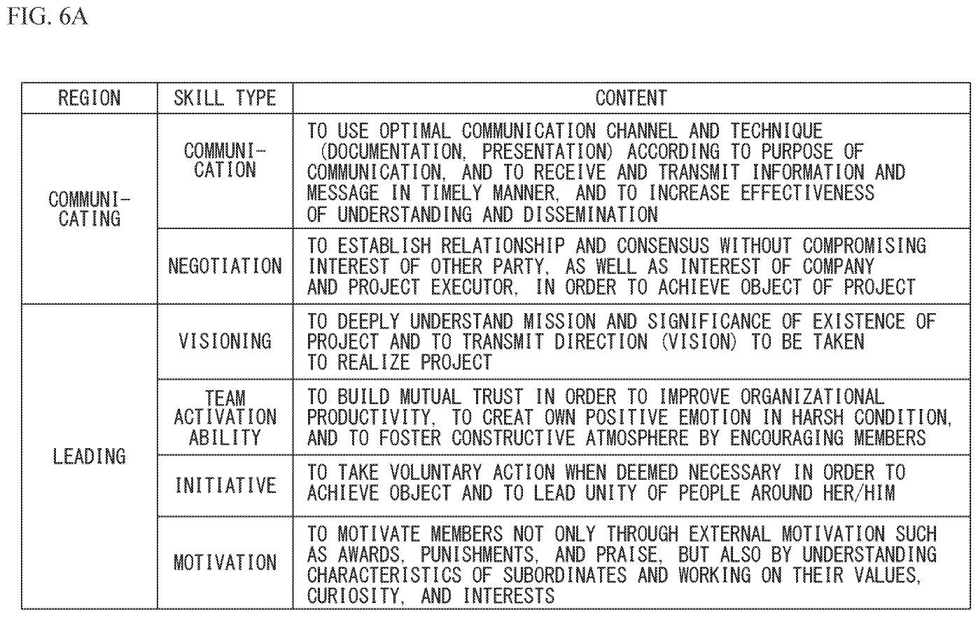

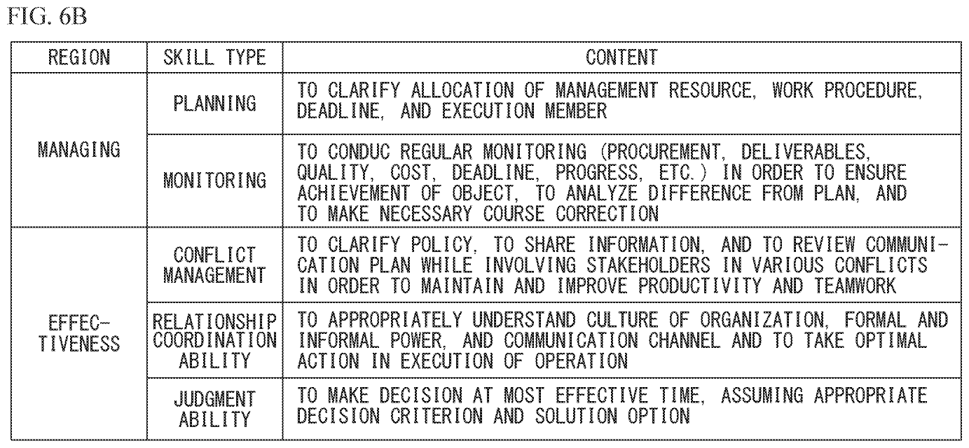

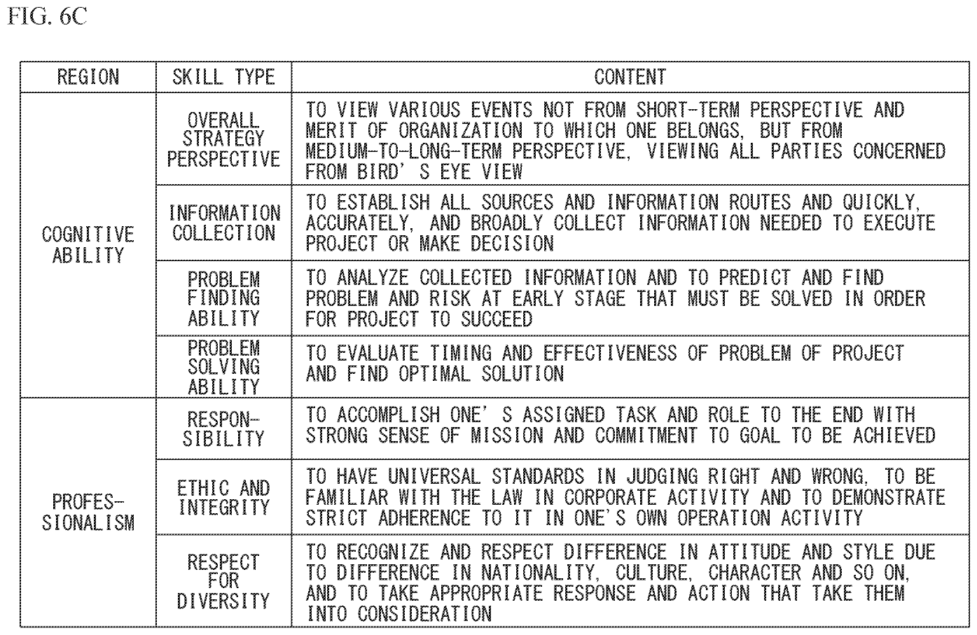

As illustrated in FIGS. 6A to 6C, the “communicating” includes “communication” and “negotiation” as a skill type. The “communication” is to use the optimal communication channels and techniques (documentation, presentation) according to the purpose of communication, and to receive and transmit information and messages in a timely manner, and to increase the effectiveness of understanding and dissemination. The “negotiation” is to establish a relationship and consensus without compromising the interests of the other party, as well as the interests of the company and the project executor, in order to achieve the object of the project.

The “leading” includes “visioning”, “team activation ability”, “initiative” and “motivation” as the skill types. The “visioning” is to deeply understand the mission and significance of existence of the project and to transmit the direction (vision) to be taken to realize the project. The “team activation ability” is to build mutual trust in order to improve organizational productivity, to create own positive emotion in harsh conditions and to foster a constructive atmosphere by encouraging members. The “initiative” is to take voluntary action when deemed necessary in order to achieve the object and to lead the unity of the people around her/him. The “motivation” is to motivate members not only through external motivation such as awards, punishments, and praise, but also by understanding the characteristics of subordinates and working on their values, curiosity, and interests.

The “managing” includes “planning” and “monitoring” as the skill types. The “planning” is to clarify allocation of management resources, work procedures, deadlines, and execution members. The “monitoring” is to conduct regular monitoring (procurement, deliverables, quality, cost, deadline, progress, etc.) in order to ensure achievement of object, to analyze differences from the plan, and to make necessary course corrections.

The “effectiveness” includes “conflict management”, “relationship coordination ability”, and “judgment ability” as the skill types. The “conflict management” is to clarify policies, to share information, and to review communication plans while involving stakeholders in various conflicts in order to maintain and improve productivity and teamwork. The “relationship coordination ability” is to appropriately understand the culture of the organization, formal and informal power, and communication channels and to take the optimal actions in the execution of operations. The “judgment ability” is to make decisions at the most effective time, assuming appropriate decision criteria and solution options.

The “cognitive ability” includes “overall strategy perspective”, “information collecting”, “problem finding ability”, and “problem solving ability” as the skill types. The “overall strategic perspective” is to view various events not from the short-term perspective and merits of the organization to which one belongs, but from a medium-to-long-term perspective, viewing all parties concerned from a bird's eye view. The “information collecting” is to establish all sources and information routes and quickly, accurately, and broadly collect the information needed to execute a project or make a decision. The “problem finding ability” is to analyze collected information and to predict and find problems and risks at an early stage that must be solved in order for the project to succeed. The “problem solving ability” is to evaluate the timing and effectiveness of a problem of the project and find the optimal solution.

The “professionalism” includes “responsibility”, “ethic and integrity”, and “respect for diversity” as the skill types. The “responsibility” is to accomplish one's assigned tasks and roles to the end with a strong sense of mission and commitment to the goal to be achieved. The “ethic and integrity” is to have universal standards in judging right and wrong, to be familiar with the law in corporate activities and to demonstrate strict adherence to it in one's own operation activities. The “respect for diversity” is to recognize and respect differences in attitudes and styles due to differences in nationality, culture, character and so on, and to take appropriate responses and actions that take them into consideration.

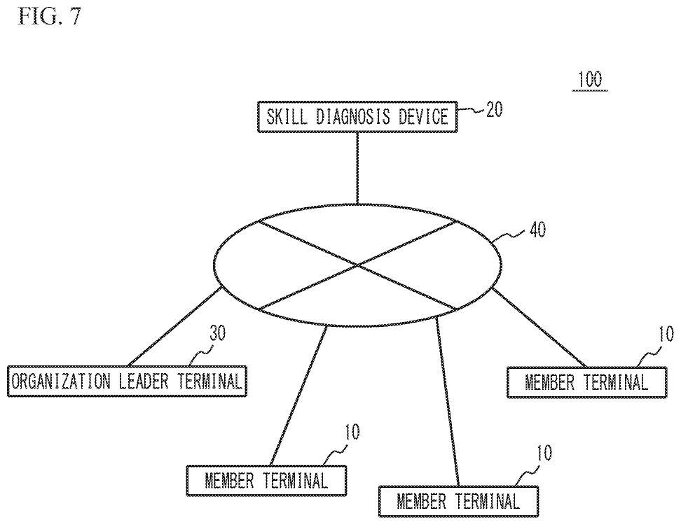

FIG. 7 is a block diagram of a skill diagnosis system 100 according to an embodiment. As illustrated in FIG. 7, the skill diagnosis system 100 has a configuration in which one or more member terminals 10 (first terminal) are connected to a skill diagnosis device 20 via a telecommunication line 40 such as the Internet, and one or more organization leader terminals 30 (second terminal) are connected to the skill diagnosis device 20 via the telecommunication line 40. The member terminal 10 transmits and receives information to and from the skill diagnosis device 20 via the telecommunication line 40. The organization leader terminal 30 transmits and receives information to and from the skill diagnosis device 20 via the telecommunication line 40. Each of the member terminal 10 and the organization leader terminal 30 may be a terminal such as a desktop PC and a notebook PC, or may be a portable terminal such as a smartphone. The skill diagnosis device 20 is a server or the like. The telecommunication line 40 may have a mixed wired and wireless configuration.

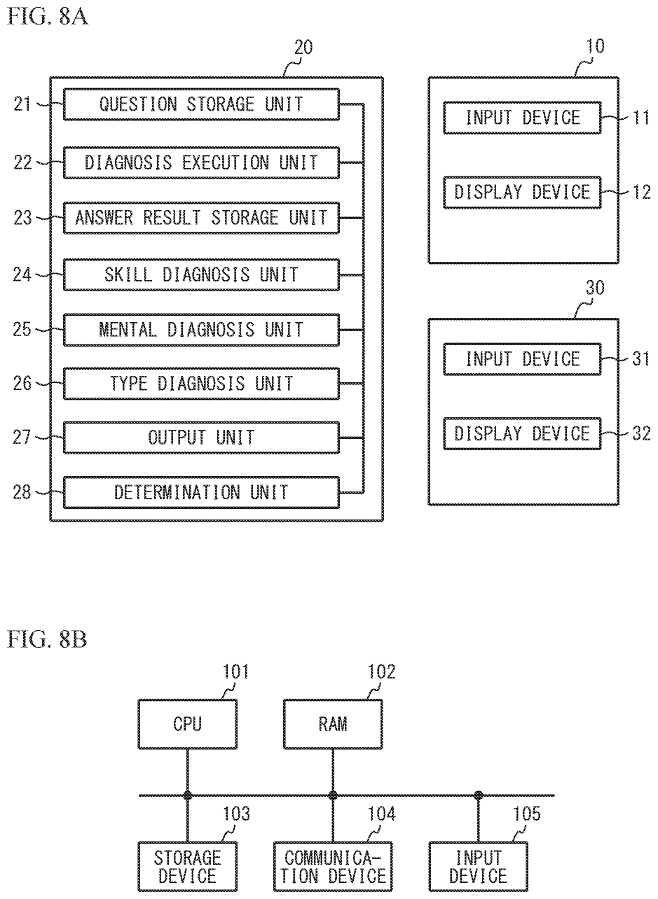

FIG. 8A is a block diagram of the member terminal 10, the skill diagnosis device 20, and the organization leader terminal 30. As illustrated in FIG. 8A, the member terminal 10 includes an input device 11, a display device 12, and the like. The organization leader terminal 30 includes an input device 31, a display device 32, and the like. The input device 31 is a keyboard, a mouse, a touch panel, or the like. The display device 32 is a liquid crystal display or the like. The skill diagnosis device 20 includes a question storage unit 21, a diagnosis execution unit 22, an answer result storage unit 23, a skill diagnosis unit 24, a mental diagnosis unit 25, a type diagnosis unit 26, an output unit 27, a determination unit 28, and the like.

FIG. 8B is a block diagram for explaining the hardware configuration of the skill diagnosis device 20. As illustrated in FIG. 8B, the skill diagnosis device 20 includes a CPU 101, a RAM 102, a storage device 103, a communication device 104, an input device 105, and the like. These devices are connected to each other by a bus or the like. The CPU (Central Processing Unit) 101 is a central processing unit. The RAM 102 is a volatile memory that temporarily stores programs executed by the CPU 101, data processed by the CPU 101, and the like. The storage device 103 is a non-volatile storage device. As the storage device 103, for example, a ROM (Read Only Memory), a solid state drive (SSD) such as a flash memory, a hard disk driven by a hard disk drive, or the like can be used. The CPU 101 executes the skill diagnosis program stored in the storage device 103, thereby realizing the functions of the respective units in the skill diagnosis device 20. The functions of the respective units in the skill diagnosis device 20 may be constituted by respective dedicated circuits or the like. The communication device 104 is an interface to the telecommunication line 40. The input device 105 is an input device such as a keyboard, a mouse, a touch panel, or the like.

The question storage unit 21 stores questions. The questions stored in the question storage unit 21 include questions for skill diagnosis and questions for mental diagnosis. The questions for skill diagnosis are classified into three categories: knowledge questions, experience questions, and competency questions. The knowledge questions are questions to understand the skill level of knowledges about project management. The experience questions are questions to understand the skill level of experiences about project management. The competency questions are questions to understand the competencies of the organization members. The competency questions include questions to be answered by the organization members belonging to the project and questions about the organization members to be answered by a person other than the organization member (for example, an organization leader who is a superior of the organization member). The mental diagnosis questions are questions to understand the mental condition of each organization member.

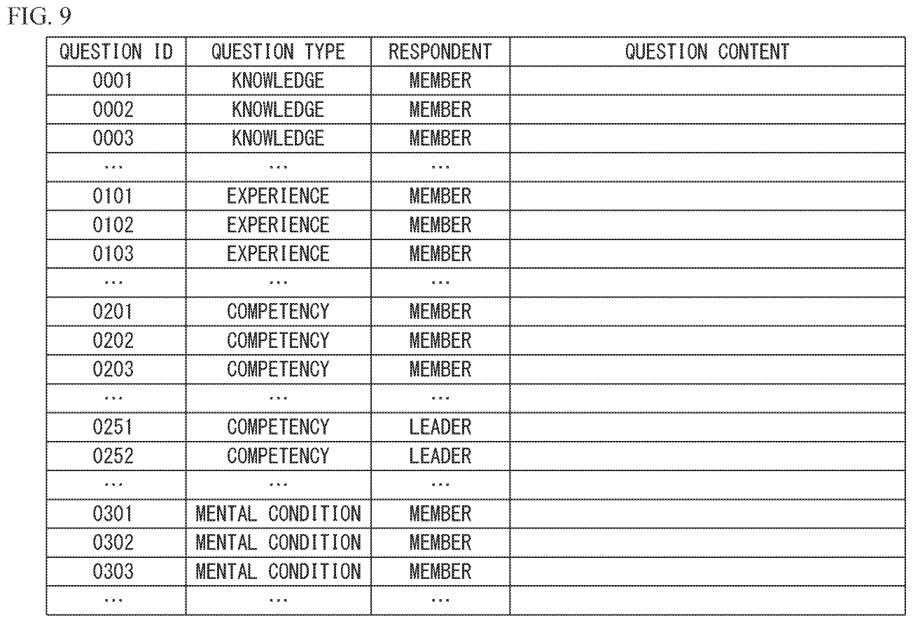

FIG. 9 is a diagram illustrating a question database stored in the question storage unit 21. As illustrated in FIG. 9, a question ID is stored in association with a question type, a respondent answering the question, and a question content. The question type is any one of knowledge, experience, competency, and mental condition. The question ID is an identifier for identifying each question.

The diagnosis execution unit 22 determines whether to start the skill diagnosis. For example, the diagnosis execution unit 22 starts the skill diagnosis for the organization member when the diagnosis execution unit 22 receives a request from the organization member via the member terminal 10. Alternatively, the diagnosis execution unit 22 starts the skill diagnosis for the designated organization member based on cycles each having a predetermined number of days. Alternatively, the diagnosis execution unit 22 starts the skill diagnosis for the organization member designated by the organization leader when the diagnosis execution unit 22 receives a request from the organization leader via the organization leader terminal 30. In addition, the diagnosis execution unit 22 determines whether to start the skill diagnosis in response to the request.

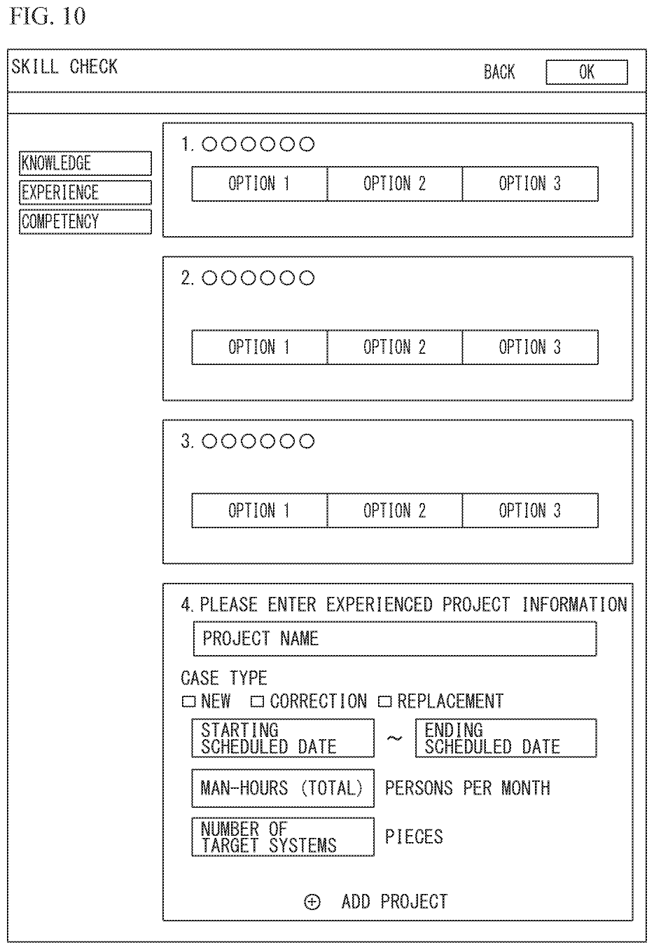

The diagnosis execution unit 22 reads the knowledge questions, the experience questions, and the competency questions stored in the question storage unit 21, and displays the knowledge questions, the experience questions, and the competency questions on the display device 12 of the member terminal 10. For the competency questions, only questions that are answered by organization members are displayed. FIG. 10 is a diagram illustrating a skill diagnosis screen displayed on the display device 12. As illustrated in FIG. 10, the display device 12 sequentially displays the respective questions. The organization member selects or inputs an answer to each question by using the input device 11 of the member terminal 10.

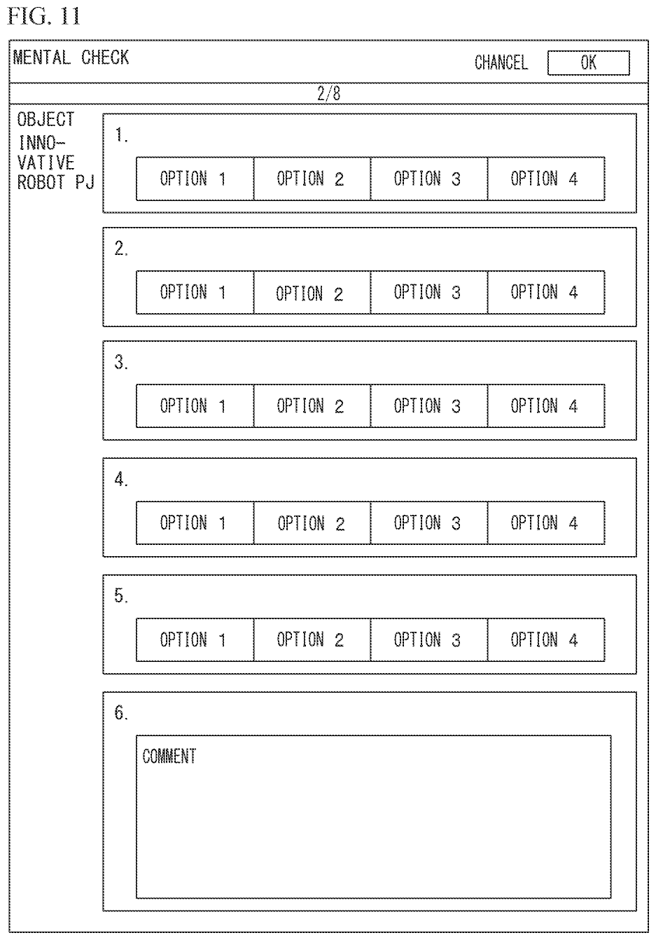

Next, the diagnosis execution unit 22 reads the question for mental diagnosis stored in the question storage unit 21 and displays it on the display device 12. FIG. 11 is a diagram illustrating a mental diagnosis screen displayed on the display device 12. As illustrated in FIG. 11, the display device 12 sequentially displays the respective questions. The organization member selects or inputs an answer to each question using the input device 11.

Next, the diagnosis execution unit 22 reads the questions to be answered by the organization leader who is the superior of the organization member, from the competency questions stored in the question storage unit 21, and displays the read questions on the display device 32 of the organization leader terminal 30. For example, a screen as illustrated in FIG. 10, which includes questions to be answered by the organization leader, is displayed. The organization leader selects or inputs an answer to each question by using the input device 31 of the organization leader terminal 30.

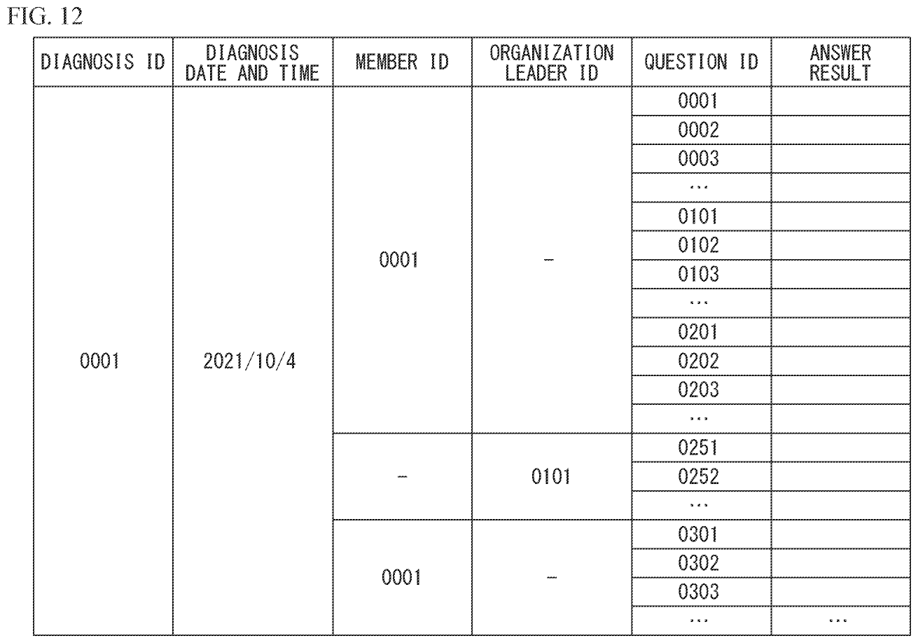

The answer result storage unit 23 stores the answers inputted through the input device 11. FIG. 12 is a diagram illustrating an input result database stored in the answer result storage unit 23. As illustrated in FIG. 12, a diagnosis date and time, a member ID, an organization leader ID, a question ID, and an inputted answer result are stored in association with a diagnosis ID. The diagnosis ID is an identifier for identifying each diagnosis. The member ID is an identifier for identifying each organization member. The organization leader ID is an identifier for identifying each organization leader. The answer result storage unit 23 stores an input result database as illustrated in FIG. 12 for diagnosis IDs for the number of times the skill diagnosis and the mental diagnosis were performed.

Next, the skill diagnosis unit 24 reads the answer result for the specific skill diagnosis ID from the answer result storage unit 23, and acquires the skill level corresponding to the answer result for each of the five regions illustrated in FIGS. 4A and 4B using a predetermined algorithm. For example, the skill diagnosis unit 24 scores the answers to the questions. In this case, for example, the higher the skill level, the higher the score. For competency, instead of scoring, the skill types illustrated in FIGS. 6A to 6C are ranked in order of increasing the action characteristics.

Next, the mental diagnosis unit 25 reads the answer result for the specific diagnosis ID from the answer result storage unit 23, and acquires the mental condition corresponding to the answer result for each predetermined mental type using a predetermined algorithm. For example, the answers to the questions are scored. In this case, for example, the score is set to be higher as the mental condition is better.

Next, the type diagnosis unit 26 reads the answer result for the specific diagnosis ID from the answer result storage unit 23, and classifies the organization member into any one of the plurality of human resource types using a predetermined algorithm. For example, since the abilities or action characteristics capable of taking specific actions tend to appear in the answer result to the competency question, the organization member can be classified into any of the plurality of human resource types using the answer result to the competency question. In the present embodiment, the organization members are classified into seven types. For example, the seven types include an “object achievement type”, a “problem solving type”, a “harmonization type”, a “pioneering type”, a “value creation type”, a “value chain type”, and a “sustainability type”.

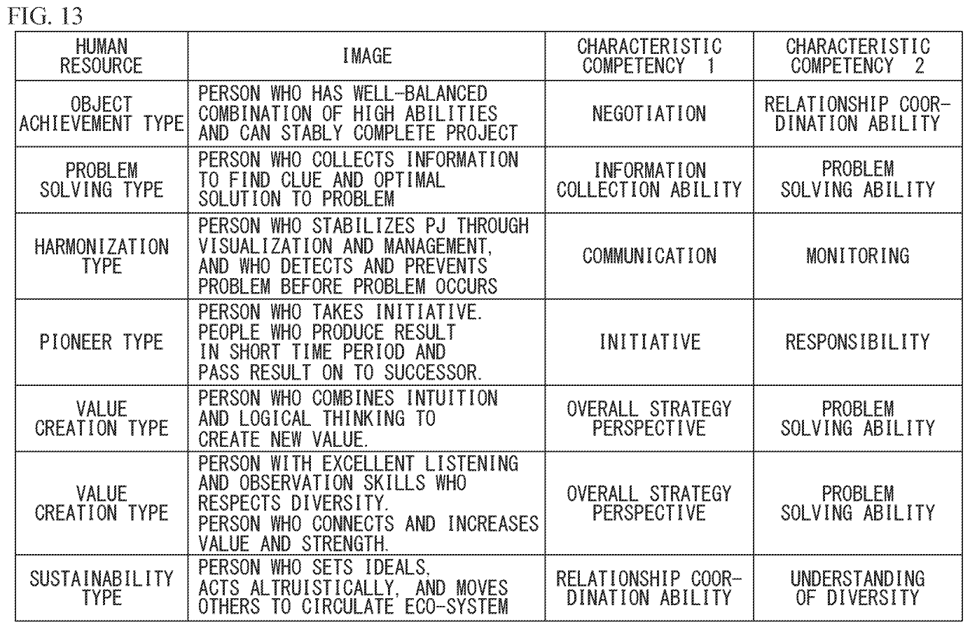

FIG. 13 is a diagram for explaining each human resource type. As illustrated in FIG. 13, a human resource image is described for each human resource type. A characteristic competency is associated with each human resource type.

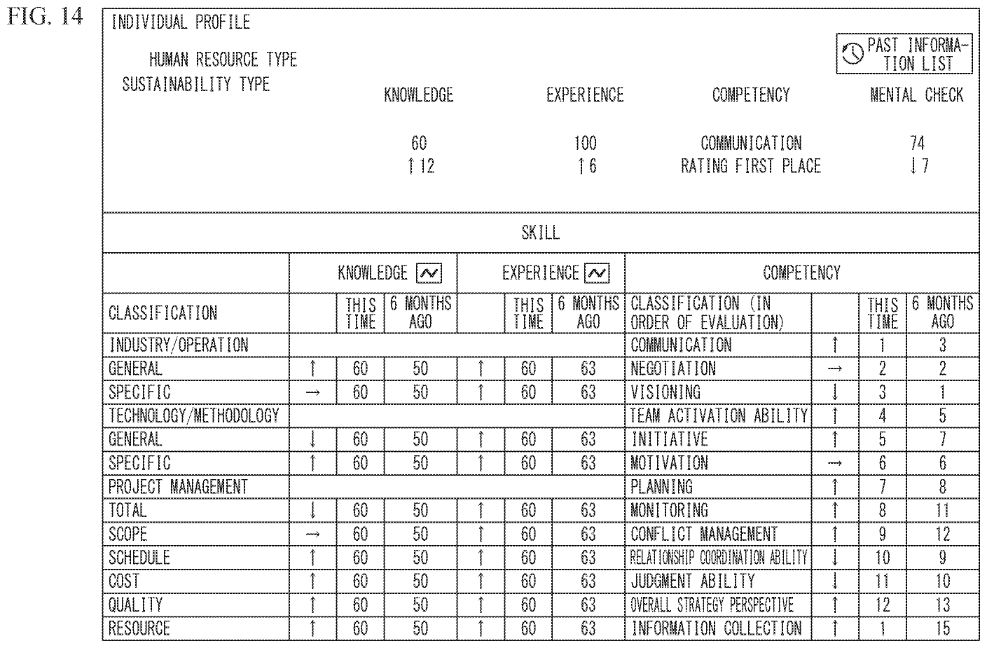

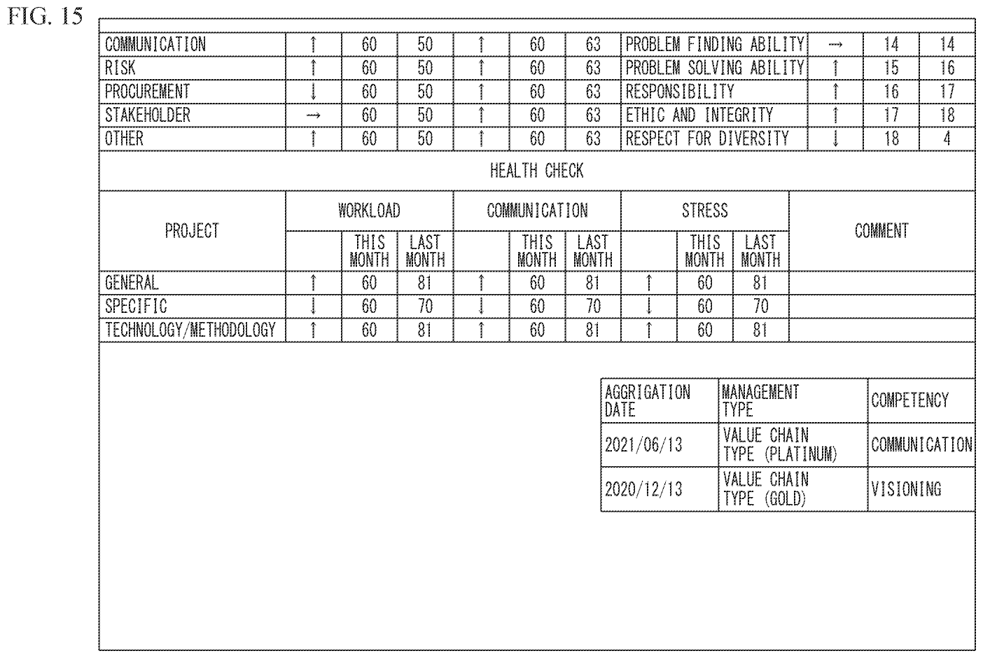

Next, the output unit 27 displays a skill diagnosis result by the skill diagnosis unit 24, a mental diagnosis result by the mental diagnosis unit 25, and a type diagnosis result by the type diagnosis unit 26 on the display device 12 of the member terminal 10. FIGS. 14 and 15 are diagrams illustrating screens of personal diagnosis results displayed on the display device 12, respectively. As illustrated in FIG. 14, the human resource type is displayed. This enables each organization member to understand his/her own human resource type. As illustrated in FIGS. 14 and 15, the skill diagnosis results are displayed. Specifically, the skill level for each skill type is displayed for each of the knowledge, experience, and competency. This enables each organization member to understand the level of skill he or she has acquired for each skill type. As illustrated in FIG. 15, the mental diagnosis result is displayed. This enables each organization member to understand his or her own mental condition. As illustrated in FIG. 15, a history from the past diagnosis results is displayed for the organization member. This enables each organization member to understand the diagnosis results in time series.

The output unit 27 also displays the screens of FIGS. 14 and 15 on the display device 32 of the organization leader terminal 30 in response to a request from the organization leader terminal 30. This enables the organization leader to understand the human resource type, the skill, and the mental condition of each organization member in detail. The organization leader can ensure appropriate assignments by referencing the human resource type, the skill level, and the mental condition of each organization member. For example, the organization leader can appropriately select a leader, a sub-leader, or non-leaders of the project from the organization members.

The output unit 27 displays the skill diagnosis result by the skill diagnosis unit 24, the mental condition diagnosis result by the mental diagnosis unit 25, and the type diagnosis result by the type diagnosis unit 26 of the organization member belonging to the project in a project unit on the display device 32 of the organization leader terminal 30 in response to a request from the organization leader terminal 30. The organization leader can determine in the project unit whether the appropriate organization member is assigned. The organization leader can also refer to the mental condition of each organization member to determine whether the mental environment for each organization member to execute the project is prepared.

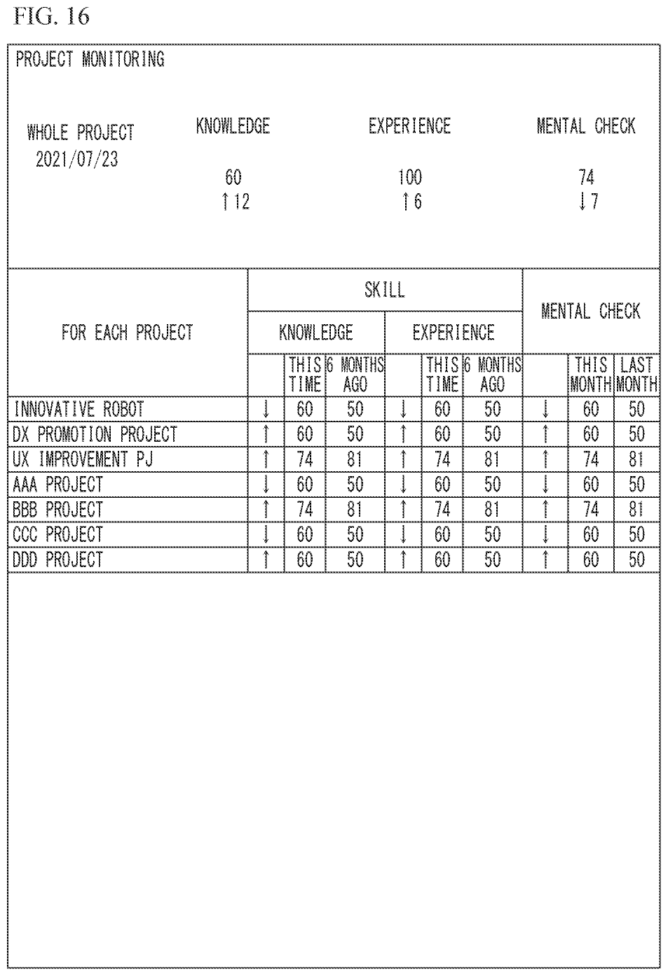

FIGS. 16 to 19 are diagrams illustrating screens of the project diagnosis results displayed on the display device 32, respectively. As illustrated in FIG. 16, the aggregated result of skill levels related to knowledge and experience is displayed in the project unit. In this case, for example, a statistical value (a relative value, an average value, a median value, a mode value, or the like) between the organization members assigned to the project, which is a total value of the skill levels of each skill type of the respective organization members assigned to the project, may be used as the skill level. A history from the past diagnosis results may be displayed.

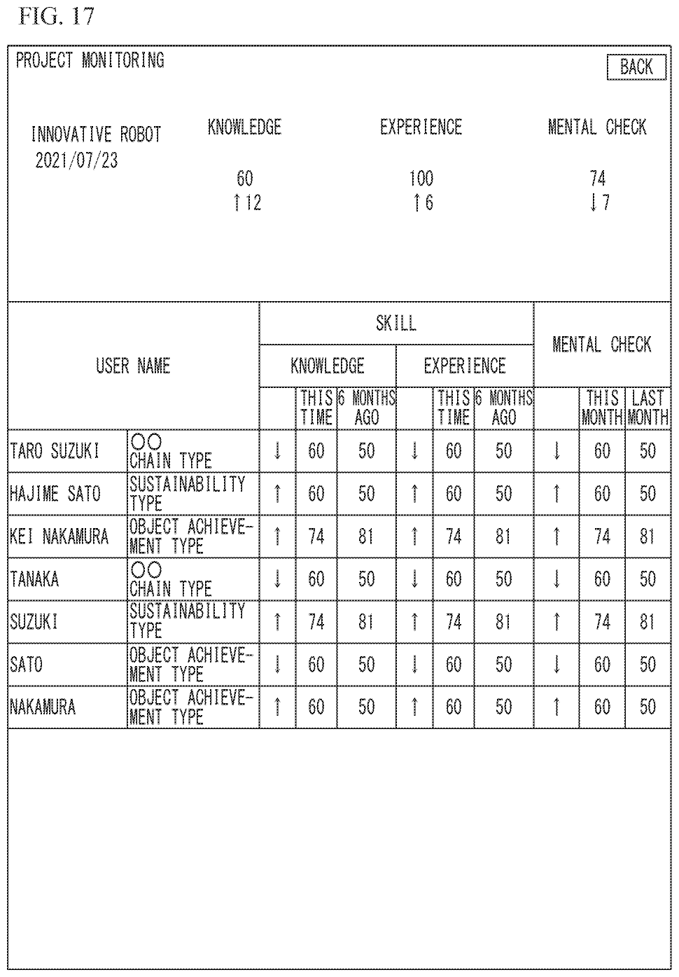

As illustrated in FIG. 17, the human resource type, the skill level, and the mental condition of each organization member belonging to the selected project in the projects included in FIG. 16 are displayed. A history from the past diagnosis results may be displayed.

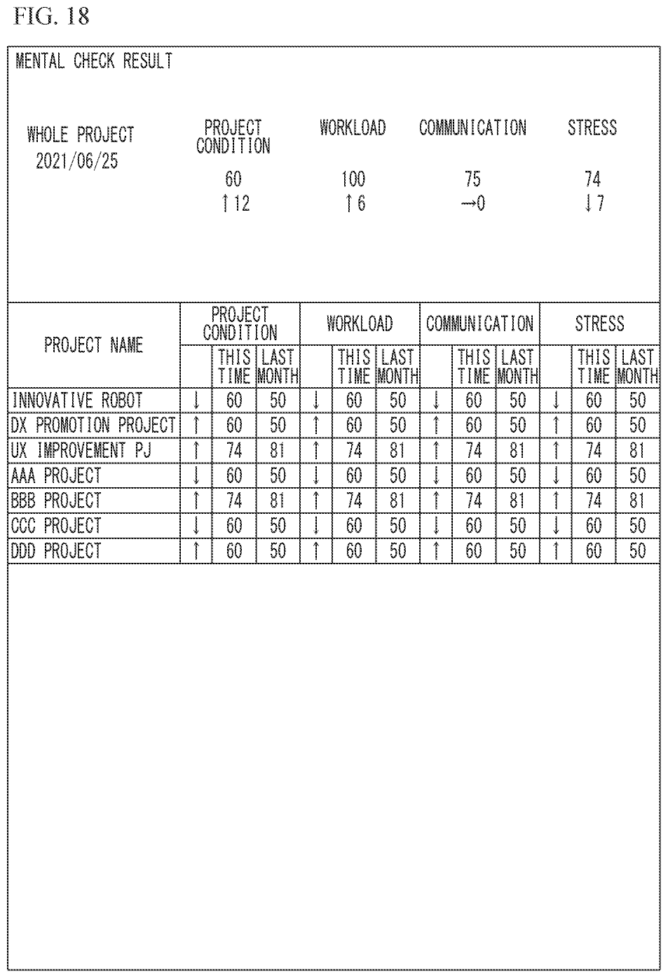

As illustrated in FIG. 18, the mental condition is displayed in the project unit. In this case, for example, a statistical value (a relative value, an average value, a median value, a mode value, or the like) between the organization members assigned to each project, which is a total value of the mental levels of each mental type of the organization members assigned to each project, can be used as the mental condition. A history from the past diagnosis results may be displayed.

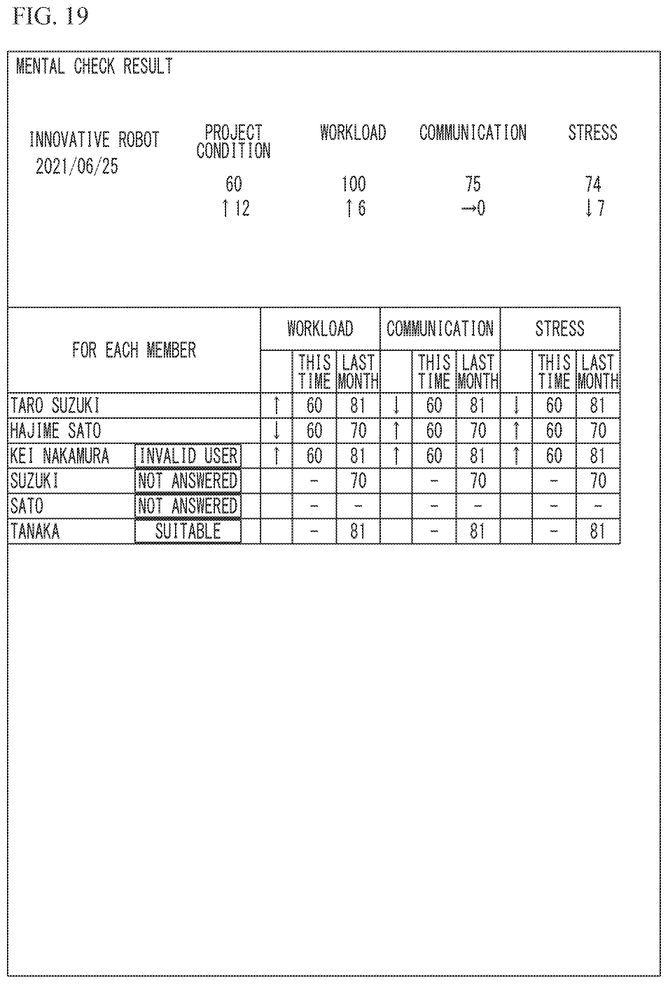

As illustrated in FIG. 19, the mental conditions of the respective organization members belonging to the selected project in the projects included in FIG. 18 are displayed.

The output unit 27 displays the skill diagnosis result by the skill diagnosis unit 24, the mental condition diagnosis result by the mental diagnosis unit 25, and the type diagnosis result by the type diagnosis unit 26 of the members belonging to the organization in an organization unit having a plurality of projects on the display device 32 of the organization leader terminal 30 in response to a request from the organization leader terminal 30.

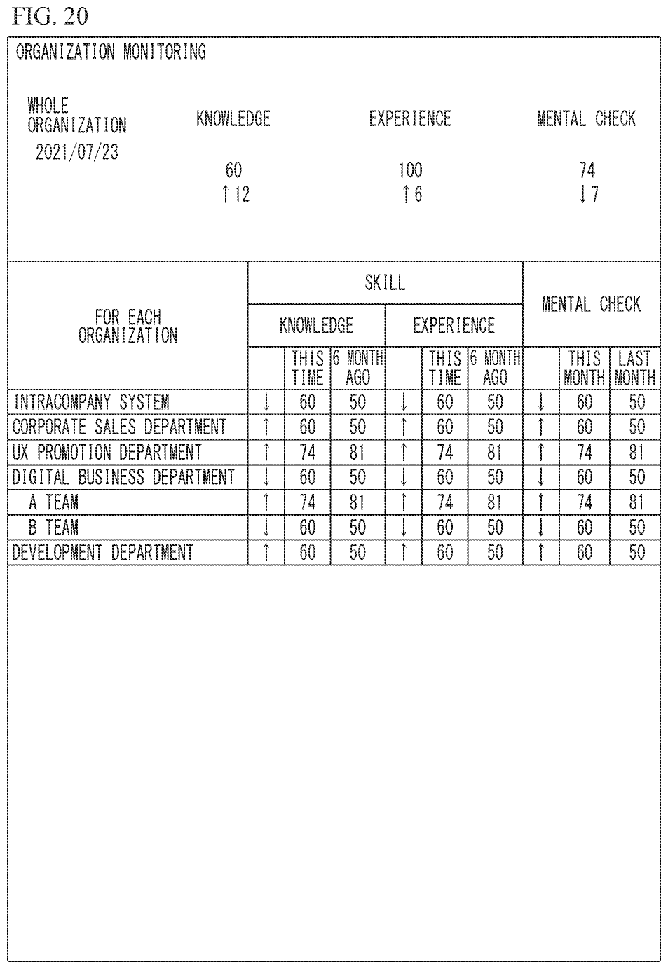

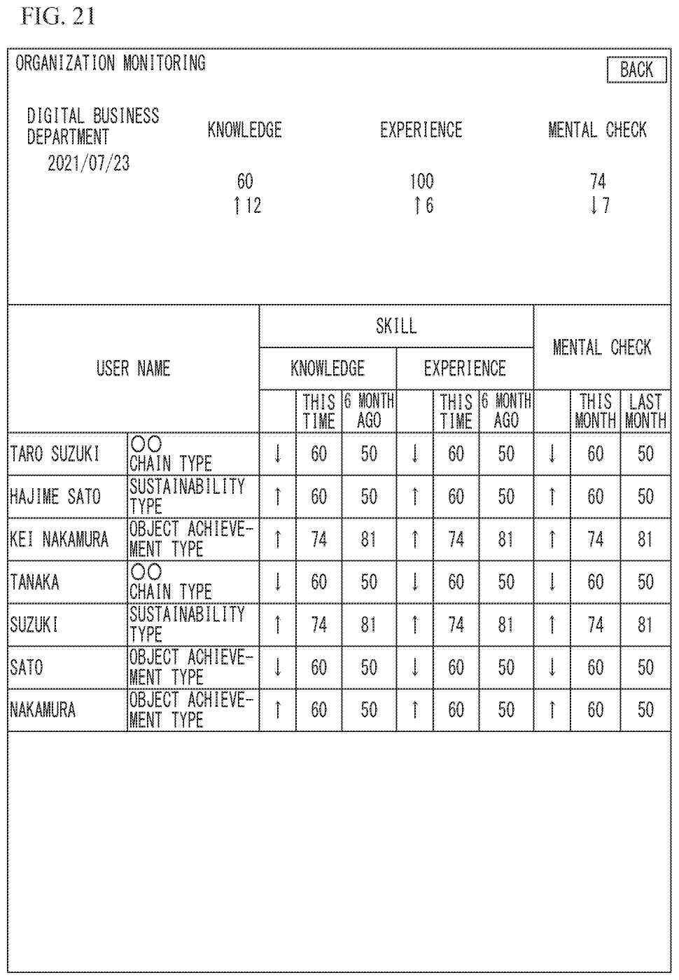

FIGS. 20 to 21 are diagrams illustrating the screens of the organization diagnosis results displayed on the display device 32, respectively. As illustrated in FIG. 20, the aggregated result of skill levels related to knowledge and experience are displayed in the organization unit. In this case, for example, a statistical value (a relative value, an average value, a median value, a mode value, or the like) between the organization members, which is a total value of the skill levels of each skill type of the respective organization members, can be used as the skill level. A history from the past diagnosis results may be displayed.

As illustrated in FIG. 21, the human resource type, the skill level, and the mental condition of each organization member belonging to the selected organization in the organizations included in FIG. 20 are displayed. A history from the past diagnosis results may be displayed.

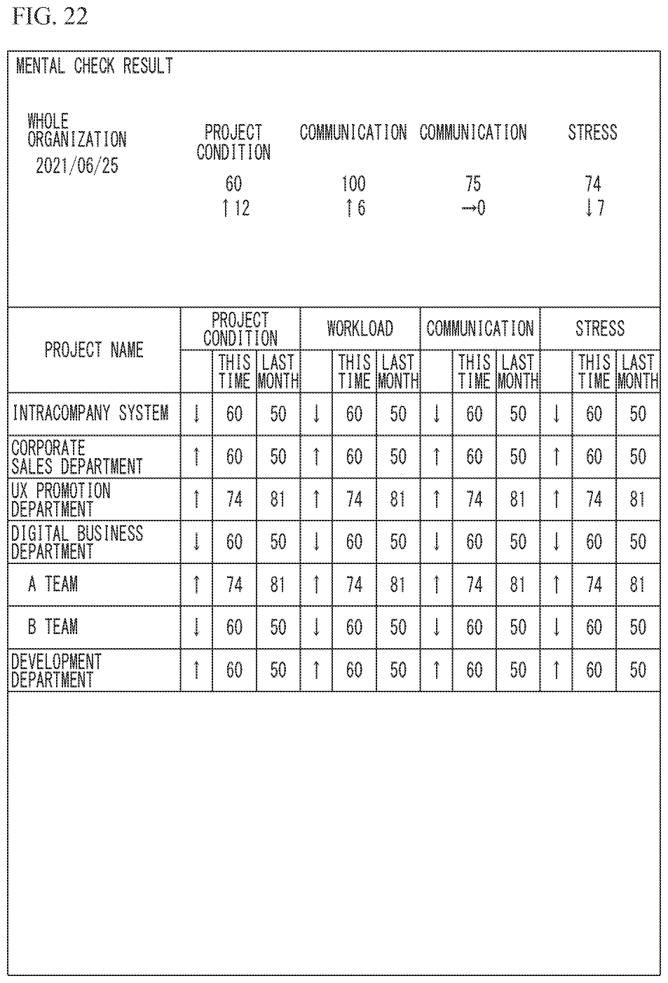

As illustrated in FIG. 22, the mental condition is displayed in the organization unit. In this case, for example, a statistical value (an average value, a median value, a mode value, or the like) between the organization members, which is a total value of the mental levels of each mental type of the respective organization members, can be used as the mental condition. A history from the past diagnosis results may be displayed.

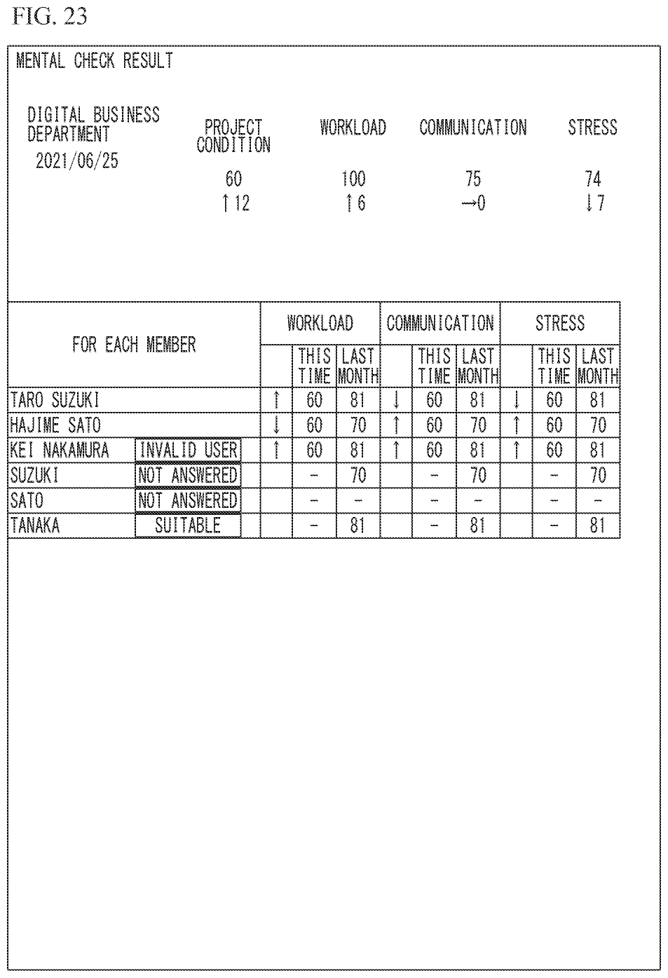

As illustrated in FIG. 23, the mental conditions of the respective organization members belonging to the selected project in the projects included in FIG. 22 are displayed.

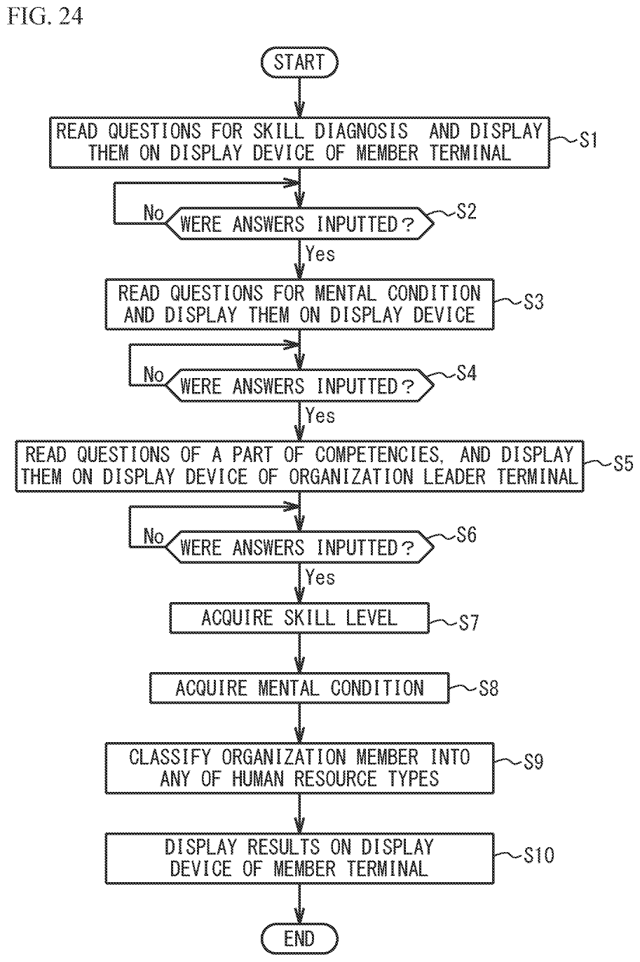

FIG. 24 is a flowchart illustrating an example of the processing executed by the skill diagnosis device 20. As illustrated in FIG. 24, the diagnosis execution unit 22 reads the knowledge questions, the experience questions, and the competency questions stored in the question storage unit 21, and displays the read knowledge questions, the experience questions, and the competency questions on the display device 12 of the designated member terminal 10 (step S1). In this case, the diagnosis execution unit 22 reads only questions to be answered by the organization members as the competency questions and displays the read questions on the display device 12. The organization member selects or inputs an answer to each question by using the input device 11 of the member terminal 10. The inputted answer is stored in the answer result storage unit 23.

Next, the diagnosis execution unit 22 determines whether the answers to all the questions displayed in step S1 have been input (step S2). If “No” is determined in step S2, step S2 is executed again after a predetermined time has elapsed.

If “Yes” is determined in step S2, the diagnosis execution unit 22 reads the mental condition question stored in the question storage unit 21 and displays the mental condition question on the display device 12 (step S3). The organization member belonging to the project selects or inputs an answer to each question by using the input device 11 of the member terminal 10. The inputted answer is stored in the answer result storage unit 23.

Next, the diagnosis execution unit 22 determines whether answers to all the questions displayed in step S3 have been input (step S4). If “No” is determined in step S4, step S4 is executed again after a predetermined time has elapsed.

If “Yes” is determined in step S4, the diagnosis execution unit 22 reads the questions to be answered by the organization leader who is the superior of the organization members from the competency questions stored in the question storage unit 21, and displays the read questions on the display device 32 of the organization leader terminal 30 (step S5). The organization leader inputs answers to the respective questions by using the input device 31 of the organization leader terminal 30. The inputted answer is stored in the answer result storage unit 23.

Next, the diagnosis execution unit 22 determines whether answers to all the questions displayed in step S5 have been input (step S6). If “No” is determined in step S6, step S6 is executed again after a predetermined time has elapsed.

Next, the skill diagnosis unit 24 reads the answer result from the answer result storage unit 23, and acquires the skill level corresponding to the answer result for each skill type illustrated in FIGS. 6A to 6C using a predetermined algorithm (step S7).

Next, the mental diagnosis unit 25 reads the answer result from the answer result storage unit 23, and acquires the mental condition corresponding to the answer result for each predetermined mental type using a predetermined algorithm (step S8).

Next, the type diagnosis unit 26 reads the answer result from the answer result storage unit 23, and classifies the organization member into any one of the plurality of human resource types using a predetermined algorithm (step S9).

Next, the output unit 27 displays the skill diagnosis result by the skill diagnosis unit 24, the mental condition diagnosis result by the mental diagnosis unit 25, and the type diagnosis result by the type diagnosis unit 26 on the display device 12 of the member terminal 10 (step S10).

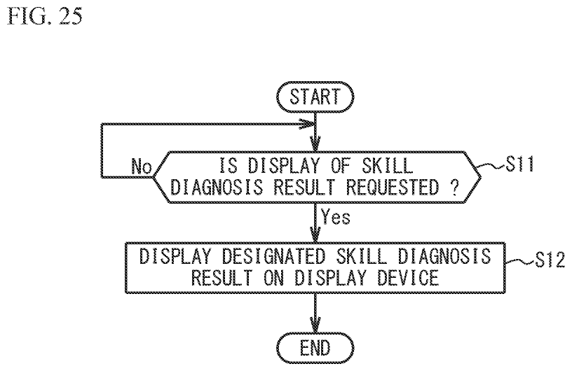

FIG. 25 is a flowchart illustrating an example of the processing executed by the skill diagnosis device 20. The output unit 27 determines whether the display of the skill diagnosis result is requested from the organization leader terminal 30 (step S11). If “No” is determined in step S11, the output unit 27 executes step S11 again after a predetermined time.

If “Yes” is determined in step S11, the output unit 27 displays the designated skill diagnosis result on the display device 32 of the organization leader terminal 30 to (step S12).

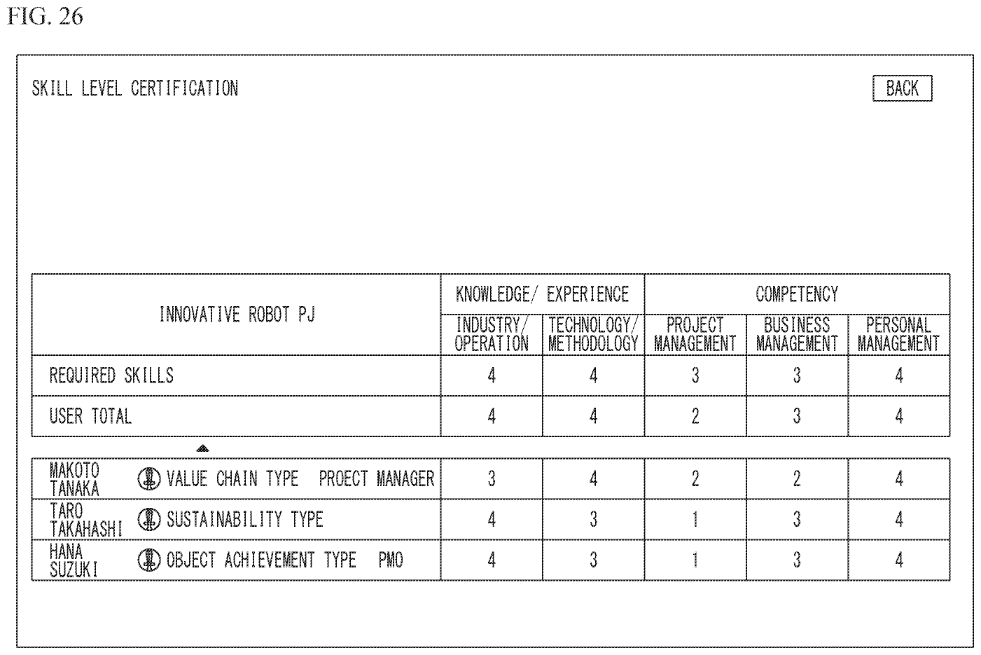

According to the present embodiment, it is possible to understand the skill level and the human resource type for each skill type of the organization member to be assigned to each project. This enables appropriate assignment by the organization leader. FIG. 26 is a diagram illustrating the assignment displayed on the display device 32 of the organization leader terminal 30. As illustrated in FIG. 26, the organization leader uses the input device 31 to input a plurality of organization members for a predetermined project (in FIG. 26, an innovative robot project). The output unit 27 displays the skill level required for each skill type for the predetermined project on the display device 32. The output unit 27 also display the total value (a relative value, an average value, a median value, a mode value, or the like) of each skill type of the plurality of inputted organization members as “user total” on the display device 32. Thereby, the organization leader can then determine whether the overall skill level of the organization members assigned to the project for a predetermined project has reached the required skill level.

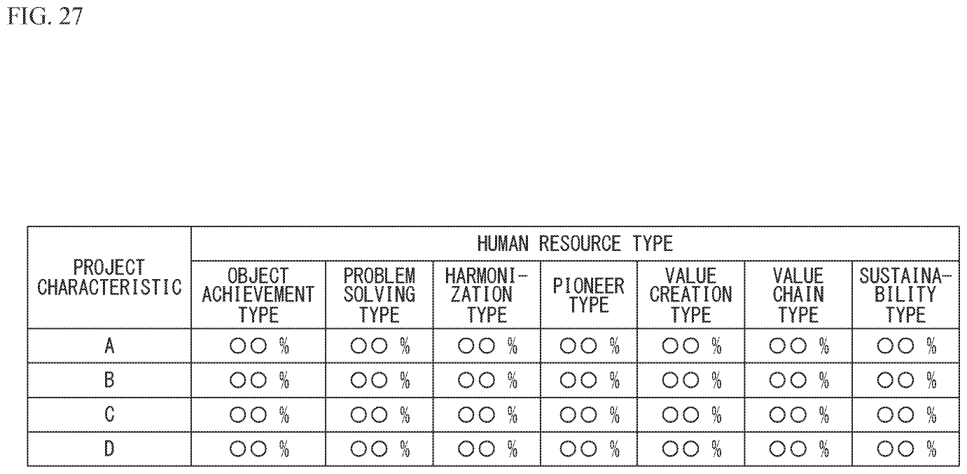

The output unit 27 may transmit a ratio of the human resource type suitable for the project management team, which is predetermined for each characteristic of the project, to any of the terminals. For example, the output unit 27 may transmit the ratio of the human resource type to the organization leader terminal 30. In this case, the ratio of the human resource type is displayed on the display device 32. FIG. 27 is a diagram illustrating the ratio of the predetermined human resource type. The organization leader can determine whether appropriate assignment have been realized by comparing the ratio of the human resource type in FIG. 27 with the human resource type of each project member displayed in FIG. 26.

The determination unit 28 may automatically determine the ratio of the human resource type. For example, the determination unit 28 may perform comparison determination between the human resource classification diagnosed by the type diagnosis unit 26 for the plurality of project members in the specific project to which the plurality of project members belong and the ratio of the human resource type determined for each characteristic of the specific project. For example, the determination unit 28 may display, on the display device 32, information indicating that the higher the similarity between the ratios of both human resource types, the more appropriate the assignment is.

Although the embodiments of the present disclosure have been described in detail, it is to be understood that the various change, substitutions, and alterations could be made hereto without departing from the spirit and scope of the invention.

What is claimed is:

1. A skill diagnosis device comprising:
a question storage configured to store a question for skill diagnosis related to project management;
a diagnosis executor configured to read the question for skill diagnosis from the question storage, transmit the question for skill diagnosis to a first terminal used by an organization member, and receive an answer result to the question for skill diagnosis from the first terminal;
an answer result storage configured to store the answer result received from the first terminal;
a diagnoser configured to diagnose a skill of the organization member based on the answer result stored in the answer result storage; and
an outputter configured to output a diagnosis result of the diagnoser;
wherein the diagnosis result includes a classification of a human resource type representing an ability or an action characteristic capable of taking a specific action.

2. The skill diagnosis device according to claim 1, wherein
the question for skill diagnosis includes a question to understand competency, and
the diagnoser diagnoses the human resource type based on an answer result to the question to understand the competency out of the answer result stored in the answer result storage.

3. The skill diagnosis device according to claim 2, wherein
the diagnosis executor transmits at least a part of a plurality of questions to understand the competency to a second terminal used by a member other than the organization member, and receives an answer result to the at least the part of the plurality of questions from the second terminal, and
the diagnoser reflects the answer result received from the second terminal in the diagnosis of the human resource type.

4. The skill diagnosis device according to claim 1, wherein
the diagnosis result includes skill levels of knowledge and experience related to the project management.

5. The skill diagnosis device according to claim 1, wherein
the question storage stores a question to understand a mental condition with respect to a project of an organization member belonging to the project,
the diagnosis executor reads the question to understand the mental condition from the question storage, transmits the question to understand the mental condition to the first terminal, and receives an answer result to the question to understand the mental condition from the first terminal, and
the diagnoser diagnoses the mental condition of the organization member belonging to the project based on the answer result to the question to understand the mental condition out of the answer result stored in the answer result storage.

6. The skill diagnosis device according to claim 1, wherein
the outputter transmits the diagnosis result of the diagnoser to the first terminal.

7. The skill diagnosis device according to claim 6, wherein
the outputter transmits a past diagnosis result with respect to the organization member by the diagnoser to the first terminal.

8. The skill diagnosis device according to claim 1, wherein
the outputter transmits an aggregate result of diagnosis results by the diagnoser for a plurality of organization members belonging to a specific project to any one of terminals in response to a request from the any one of terminals.

9. The skill diagnosis device according to claim 8, wherein
the outputter transmits a ratio of the human resource types determined for each characteristic of a project to any one of terminals.

10. The skill diagnosis device according to claim 1, further comprising:
a determiner configured to perform comparison determination between a classification of the human resource type diagnosed by the diagnoser for a plurality of organization members in a specific project to which the plurality of organization members belong and a ratio of a human resource type determined for each characteristic of the specific project.

11. A skill diagnosis method executed by a computer to execute a process, the computer including a question storage configured to store a question for skill diagnosis related to project management, the process comprising:
reading the question for skill diagnosis from the question storage, transmitting the question for skill diagnosis to a first terminal used by an organization member, and receiving an answer result to the question for skill diagnosis from the first terminal;
storing the answer result received from the first terminal;
diagnosing a skill of the organization member based on the stored answer result; and
outputting a diagnosis result;
wherein the diagnosis result includes a classification of a human resource type representing an ability or an action characteristic capable of taking a specific action.

12. A non-transitory computer-readable recording medium having stored therein a program for causing a computer to execute a process, the computer including a question storage configured to store a question for skill diagnosis related to project management, the process comprising:
reading the question for skill diagnosis from the question storage, transmitting the question for skill diagnosis to a first terminal used by an organization member, and receiving an answer result to the question for skill diagnosis from the first terminal;
storing the answer result received from the first terminal;
diagnosing a skill of the organization member based on the stored answer result; and
outputting a diagnosis result;
wherein the diagnosis result includes a classification of a human resource type representing an ability or an action characteristic capable of taking a specific action.
